(19) United States
(12) Patent Application Publication
(10) Pub. No.: US 2024/0132699 A1
(43) Pub. Date: Apr. 25, 2024

(54) USE OF POLYHYDRIC ALCOHOLS TO INCREASE WELD SEAM STRENGTH AFTER THERMAL AGING IN POLYAMIDES

(71) Applicant: BASF SE, Ludwigshafen am Rhein (DE)

(72) Inventors: Sebastian WAGNER, Ludwigshafen (DE); Michael ROTH, Ludwigshafen (DE); Stefan MOCHEV, Ludwigshafen (DE)

(21) Appl. No.: 18/519,323

(22) Filed: Nov. 27, 2023

Related U.S. Application Data
(62) Division of application No. 16/963,781, filed on Oct. 5, 2020.

(30) Foreign Application Priority Data
Feb. 2, 2018 (EP) 18154889.2

(51) Int. Cl. C08K 5/053; B29C 45/00; C08K 3/014; C08K 5/00; C08K 7/14; C08L 77/02; C08L 77/06

(52) U.S. Cl. CPC C08K 5/053; B29C 45/0001; B29C 45/0005; B29C 45/0025; C08K 3/014; C08K 5/005; C08K 7/14; C08L 77/02; C08L 77/06

(57) ABSTRACT

Described herein are polyhydric alcohols having more than two hydroxyl groups in polyamide compositions including at least one polyamide to increase the weld seam strength after thermal aging of shaped articles produced from the polyamide composition by injection molding. During the injection molding, at least two flow fronts of the polyamide composition collide and form at least one weld seam.

### CROSS-REFERENCE TO RELATED APPLICATIONS

This application is a divisional application of U.S. patent application Ser. No. 16/963,781, filed on Oct. 5, 2020, which is a U.S. National Phase Application of PCT/EP2019/052313, filed on Jan. 31, 2019, which claims the benefit of priority to European Patent Application Number 18154889.2, filed Feb. 2, 2018, the entire contents of which are hereby incorporated by reference herein.

### DESCRIPTION

The invention relates to the use of polyhydric alcohols having more than two hydroxyl groups and to a corresponding process.

Polyamides are among the polymers produced on a large scale globally and, in addition to their main fields of use in films, fibers and shaped articles (materials), serve a multitude of other end uses. Among the polyamides, polyamide-6 (polycaprolactam, PA 6) and polyamide-6,6 (Nylon, polyhexamethyleneadipamide) are the polymers produced in the largest volumes. Most polyamides of industrial significance are semicrystalline thermoplastic polymers featuring a high thermal stability.

Shaped articles composed of polyamides may be produced by injection molding for example. This generally forms (dynamic) weld seams. A distinction is generally made between static and dynamic weld seams. Static weld seams are formed for example during the welding process when joining thermoplastic moldings. A dynamic weld seam is formed in a plastic component in injection molding due to confluence of at least two mass flows, for example downstream of cavities, due to wall thickness differences or due to a plurality of gates or injection sites in the mold. When two flow fronts collide, a weld seam, also known as a weld line or flow line, is formed at the point of confluence. These seams are apparent as visible lines. A weld seam is thus an often visible surface effect on injection molded parts.

A weld seam is a potential weak point in the component. On account of a volume expansion the flow fronts collide vertically and weld together. The lower the pressure and the temperature the lower the strength of the weld seam. Due to the shear acting during the injection molding process and the flow conditions reinforcing fibers often orient parallel to the weld seam. If the melt has already cooled to such an extent that a welding of the colliding melt fronts can no longer occur completely the weld seam is often apparent as a V-shaped notch at the surface. If tensile stresses were to occur in this region the notch effect brings about a stress superelevation at the weld seam which then acts as a pre-weakened breakage point.

It is known from WO 2010/014801 to produce heat-resistant polyamide shaped articles in which the polyamide is admixed with polyhydric alcohols, such as pentaerythritol, dipentaerythritol, tripentaerythritol, ditrimethylolpropane, D-mannitol, D-sorbitol or xylitol. Polyamide mixtures are also employable. In the exemplary embodiments the polyamide mixtures comprise a relatively large proportion of an at least semiaromatic polyamide and a relatively small proportion of an aliphatic polyamide. WO 201194553 describes such polyhydroxy polymers for comparable applications.

EP-B-2 307 480 relates to heat-resistant thermoplastic articles comprising co-stabilizers.

The articles are produced from polyamide compositions comprising at least one polyhydric alcohol having more than two hydroxyl groups and a number-average molecular weight (M) of less than 2000 and also co-stabilizers selected from secondary arylamines and hindered amine light stabilizers (HALS) and mixtures thereof. The polyamide resin additionally comprises reinforcers.

The shaped articles produced from the polyamides by injection molding are said to have good mechanical properties even after relatively lengthy thermal aging at high temperatures.

It is an object of the present invention to provide polyamide compositions suitable for producing injection molded shaped articles having an elevated weld seam strength after thermal aging.

The object is achieved according to the invention through the use of polyhydric alcohols having more than two hydroxyl groups in polyamide compositions comprising at least one polyamide to increase the weld seam strength after thermal aging of shaped articles produced from the polyamide composition by injection molding, wherein during injection molding at least two flow fronts of the molten polyamide composition collide and form at least one weld seam.

The object is further achieved by a process for increasing the weld seam strength after thermal aging of shaped articles produced from polyamide compositions by injection molding comprising the polyamide composition with 0.1% to 10% by weight based on the total polyamide composition of at least one polyhydric alcohol having more than two hydroxyl groups prior to production of the shaped articles and injection molding the thus obtained polyamide composition to produce the shaped articles, wherein during injection molding at least two flow fronts of the molten polyamide composition collide and form at least one weld seam.

It was found according to the invention that the use of polyhydric alcohols having more than two hydroxyl groups in polyamide compositions comprising at least one polyamide brings about an increase in the weld seam strength after thermal aging of shaped articles produced from the polyamide composition by injection molding. Weld seam strength is a specific criterion in shaped articles produced by injection molding, wherein during injection molding at least two flow fronts of the molten polyamide composition collide and form at least one weld seam.

According to the invention the term “weld seam” is to be understood as meaning a dynamic weld seam as described at the outset. The term “weld seam” may also be substituted by the terms “flow line” or “weld line”. It is essential that the weld seam is obtained by injection molding of the polyamide composition. The weld seams are often the weak points in an injection molded shaped article. Especially in the case of excessively rapid cooling of the polyamide composition on the mold wall of the injection mold the confluent mass flows can no longer optimally join. This results in formation of weld seams or else of small notches which then constitute a weak point in the injection molded part. Mechanical stress often brings about a fracture along the weld seam/flow line or a fracture starts in this region. Weld seam strength is therefore important for the strength of the injection molded shaped article as a whole.

The mechanical properties of the injection molded shaped articles often deteriorate upon thermal aging taking place over the lifetime of the shaped article. Increasing the weld seam strength after thermal aging for injection molded shaped articles is therefore particularly important.

The use of polyhydric alcohols in polyamide compositions typically impairs mechanical properties, especially in the case of extrusion and injection molding to afford shaped articles. This is a result of chemical decomposition of the base polymer by the alcohol (reduction in viscosity number) while short-chain alcohols also have a tendency for migration at certain concentrations and combinations (see also EP 1 797 132 B1).

However, it was found according to the invention that the weld seam strength after thermal aging can be increased through the addition of the polyhydric alcohols. In addition, the use of high molecular weight alcohols, for example polyvinyl alcohol copolymers, made it possible to improve surface quality through reduced migration. These copolymers ideally have an MFR (210° C./2.16 kg) of between 2 and 20 g/10 min.

The co-use of heat stabilizers selected from copper compounds, secondary aromatic amines, sterically hindered phenols, phosphites, phosphonites and mixtures thereof may also be advantageous. Polyhydric alcohols exhibit a weld seam strength-increasing effect, especially in the case of thermal aging at temperatures of at least 140° C., for example at 180° C. to 220° C. The additional heat stabilizers can additionally increase the weld seam strength at relatively low temperatures, for example in the range up to 150° C., for example at 140° C. Combination of the polyhydric alcohols with the recited additional heat stabilizers can thus achieve an increase in the weld seam strength after thermal aging over a broad temperature range.

In addition, combination of polyamides with copolyamides or terpolyamides and polyhydric alcohols affords polyamide compositions which show good weld seam strengths that do not decline excessively even after relatively lengthy thermal aging. These effects are apparent especially for a combination of aliphatic polyamide with aliphatic copolyamide or terpolyamide.

The use according to the invention and the process according to the invention preferably employ a polyamide composition comprising
a) 30% to 99.9% by weight of at least one polyamide as component A),
b) 0% to 60% by weight of glass fibers as component B),
c) 0% to 2% by weight of heat stabilizers selected from copper compounds, secondary aromatic amines, sterically hindered phenols, phosphites, phosphonites and mixtures thereof as component C),
d) 0.1% to 10% by weight of at least one polyhydric alcohol comprising more than two hydroxyl groups as component D),
e) 0% to 20% by weight of further additives as component E), wherein the reported amounts summing to 100% by weight are based on the total composition.

In one embodiment of the invention the polyamide composition comprises not more than 2.9% by weight, particularly preferably not more than 2.0% by weight, especially not more than 1.5% by weight, of impact modifiers such as are described for example in US 2013/0253115 A1.

The polyamide composition preferably also comprises no ethylene ionomer resins such as are described for example in U.S. Pat. No. 4,885,340.

In one embodiment of the invention the polyamide molding composition preferably comprises no monoepoxy or carbonate compounds, such as are described as compounds (C) of general formula (I) in U.S. Pat. No. 4,885,340.

In one embodiment of the invention the polyhydric alcohol is not glycerol.

The polyamide compositions employed in accordance with the invention comprise 30% to 99.9% by weight, preferably 40% to 99.5% by weight, in particular 50% to 98.5% by weight of the component A).

They further comprise 0% to 60% by weight, preferably 0% to 40% by weight, especially 0% to 30% by weight, of the component B). When component B) is present the minimum amount is preferably 5% by weight, particularly preferably at least 10% by weight, in particular at least 15% by weight. This results in ranges of 5% to 60% by weight, preferably 10% to 40% by weight, particularly preferably 15% to 30% by weight, of the component B).

Component C) is employed in an amount of 0% to 2% by weight, preferably 0% to 1% by weight, particularly preferably 0% to 0.5% by weight. If component C) is co-used the lower limit is preferably 0.01% by weight, particularly preferably 0.02% by weight, in particular 0.05% by weight. This therefore results in quantity ranges of 0.01% to 2% by weight, preferably 0.02% to 1% by weight, particularly preferably 0.05% to 0.5% by weight.

The component D) is employed in an amount of 0.1% to 10% by weight, preferably 0.5% to 5% by weight, in particular 1.5% to 3% by weight.

Component E) is employed in an amount of 0% to 20% by weight, preferably 0% to 10% by weight, in particular 0% to 5% by weight. If component E) is co-used the lower limit is preferably 0.1% by weight, particularly preferably at least 0.2% by weight, in particular at least 0.3% by weight. This results in ranges of 0.1% to 20% by weight, preferably 0.2% to 10% by weight, particularly preferably 0.3% to 5% by weight, in particular 0.3% to 2% by weight.

When components B), C) and/or E) are present the maximum amount of the component A) is reduced correspondingly by the minimum amounts of the respective components and/or the sum of these minimum amounts. When component B) is present in a minimum amount of 5% by weight the maximum amount of the component A) for example is thus reduced to 94.9% by weight.

If in addition the minimum amounts of components C) and E) of 0.01% and 0.1% by weight, respectively, are present the maximum amount of the component A) is correspondingly reduced to 94.7% by weight. The other quantity ranges are treated correspondingly and the total amount of the components A) to E) therefore always sums to 100% by weight.

The polyamide composition employed in accordance with the invention comprises at least one synthetic polyamide as component A). In the context of the invention the term “synthetic polyamide” is to be interpreted broadly. It very generally covers polymers incorporating at least one component which is suitable for polyamide formation and is selected from dicarboxylic acids, diamines, salts of at least one dicarboxylic acid and at least one diamine, lactams, w-amino acids, aminocarbonitriles and mixtures thereof. As well as the components suitable for polyamide formation, the synthetic polyamides of the invention may also comprise monomers copolymerizable therewith in copolymerized form. The term “synthetic polyamide” does not include natural polyamides, such as peptides and proteins, for example hair, wool, silk and albumen.

In the context of the invention the polyamides are referred to using abbreviations, some of which are customary in the art, which consist of the letters PA followed by numbers and letters. Some of these abbreviations are standardized in DIN EN ISO 1043-1. Polyamides which can be derived from aminocarboxylic acids of the H₂N—(CH₂)ₓ—COOH type or the corresponding lactams are identified as PA Z where Z denotes the number of carbon atoms in the monomer. For example, PA 6 represents the polymer of caprolactam or of ω-aminocaproic acid. Polyamides derivable from diamines and dicarboxylic acids of the H₂N—(CH₂)ₓ-NH₂ and HOOC—(CH₂)_{y}—COOH types are identified as PA Z1Z2 where Z1 denotes the number of carbon atoms in the diamine and Z2 the number of carbon atoms in the dicarboxylic acid. Copolyamides are designated by listing the components in the sequence of their proportions, separated by slashes. For example, PA 66/610 is the copolyamide of hexamethylenediamine, adipic acid and sebacic acid. For the monomers having an aromatic or cycloaliphatic group which are used in accordance with the invention, the following letter abbreviations are used: T=terephthalic acid, I=isophthalic acid, MXDA=m-xylylenediamine, IPDA=isophoronediamine, PACM=4,4′-methylenebis(cyclohexylamine), MACM=2,2′-dimethyl-4,4′-methylenebis(cyclohexylamine).

Hereinbelow the expression “C₁-C₄-alkyl” encompasses unsubstituted straight-chain and branched C₁-C₄-alkyl groups. Examples of C₁-C₄-alkyl groups are especially methyl, ethyl, propyl, isopropyl, n-butyl, isobutyl, sec-butyl, tert-butyl (1,1-dimethylethyl).

In the case of the aliphatic dicarboxylic acids, cycloaliphatic dicarboxylic acids, aromatic dicarboxylic acids and monocarboxylic acids recited hereinbelow the carboxyl groups may each be present in underivatized form or in the form of derivatives. In the case of dicarboxylic acids, neither carboxyl group, one carboxyl group or both carboxyl groups may be in the form of a derivative. Suitable derivatives are anhydrides, esters, acid chlorides, nitriles and isocyanates. Preferred derivatives are anhydrides or esters. Anhydrides of dicarboxylic acids may be in monomeric or in polymeric form. Preferred esters are alkyl esters and vinyl esters, particularly preferably C₁-C₄-alkyl esters, particularly methyl esters or ethyl esters. Dicarboxylic acids are preferably in the form of mono- or dialkyl esters, particularly preferably mono- or di-C₁-C₄-alkyl esters, in particular monomethyl esters, dimethyl esters, monoethyl esters or diethyl esters. Dicarboxylic acids are moreover preferably in the form of mono- or divinyl esters. Dicarboxylic acids are moreover preferably in the form of mixed esters, particularly preferably mixed esters with different C₁-C₄-alkyl components, especially methyl ethyl esters.

The components suitable for polyamide formation are preferably selected from
pA) unsubstituted or substituted aromatic dicarboxylic acids and derivatives of unsubstituted or substituted aromatic dicarboxylic acids,
pB) unsubstituted or substituted aromatic diamines,
pC) aliphatic or cycloaliphatic dicarboxylic acids,
pD) aliphatic or cycloaliphatic diamines,
pE) monocarboxylic acids,
pF) monoamines,
pG) at least trifunctional amines,
pH) lactams,
pI) ω-amino acids,
pK) compounds distinct from and co-condensable with pA) to pI).

One suitable embodiment is that of aliphatic polyamides. For aliphatic polyamides of the PA Z1 Z2 type (such as PA 66), the proviso applies that at least one of components pC) and pD) must be present and neither of components pA) and pB) may be present. For aliphatic polyamides of the type PA Z (such as PA 6 or PA 12) the proviso applies that at least component pH) must be present.

A further suitable embodiment is that of semiaromatic polyamides. For semiaromatic polyamides the proviso applies that at least one of components pA) and pB) and at least one of components pC) and pD) must be present.

The aromatic dicarboxylic acids pA) are preferably selected from in each case unsubstituted or substituted phthalic acid, terephthalic acid, isophthalic acid, naphthalenedicarboxylic acids or diphenyldicarboxylic acids, and the derivatives and mixtures of the aforementioned aromatic dicarboxylic acids.

Substituted aromatic dicarboxylic acids pA) preferably have at least one (e.g. 1, 2, 3 or 4) C₁-C₄-alkyl radical. In particular, substituted aromatic dicarboxylic acids pA) have 1 or 2 C₁-C₄-alkyl radicals. These are preferably selected from methyl, ethyl, n-propyl, isopropyl, n-butyl, isobutyl, sec-butyl and tert-butyl, particularly preferably methyl, ethyl and n-butyl, particularly methyl and ethyl and especially methyl. Substituted aromatic dicarboxylic acids pA) may also bear further functional groups which do not disrupt the amidation, for example 5-sulfoisophthalic acid, and salts and derivatives thereof. A preferred example thereof is the sodium salt of dimethyl 5-sulfoisophthalate.

The aromatic dicarboxylic acid pA) is preferably selected from unsubstituted terephthalic acid, unsubstituted isophthalic acid, unsubstituted naphthalenedicarboxylic acids, 2-chloro-terephthalic acid, 2-methylterephthalic acid, 5-methylisophthalic acid and 5-sulfoisophthalic acid.

It is particularly preferable when the employed aromatic dicarboxylic acid pA) is terephthalic acid, isophthalic acid or a mixture of terephthalic acid and isophthalic acid.

The semiaromatic polyamides preferably have a proportion of aromatic dicarboxylic acids among all the dicarboxylic acids of at least 50 mol %, particularly preferably of 70 mol % to 100 mol %. In a specific embodiment, the semiaromatic polyamides have a proportion of terephthalic acid or isophthalic acid or a mixture of terephthalic acid and isophthalic acid, based on all the dicarboxylic acids, of at least 50 mol %, preferably of 70 mol % to 100 mol %.

The aromatic diamines pB) are preferably selected from bis(4-aminophenyl)methane, 3-methylbenzidine, 2,2-bis(4-aminophenyl) propane, 1,1-bis(4-aminophenyl)cyclohexane, 1,2-diaminobenzene, 1,4-diaminobenzene, 1,4-diaminonaphthalene, 1,5-diaminonaphthalene, 1,3-diaminotoluene(s), m-xylylenediamine, N,N′-dimethyl-4,4′-biphenyldiamine, bis(4-me-thylaminophenyl)methane, 2,2-bis(4-methylaminophenyl)propane or mixtures thereof.

The aliphatic or cycloaliphatic dicarboxylic acids pC) are preferably selected from oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, maleic acid, fumaric acid or itaconic acid, cis- and trans-cyclohexane-1,2-dicarboxylic acid, cis—and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid and mixtures thereof.

The aliphatic or cycloaliphatic diamines pD) are preferably selected from ethylenediamine, propylenediamine, tetramethylenediamine, heptamethylenediamine, hexamethylenediamine, pentamethylenediamine, octamethylenediamine, nonamethylenediamine, decamethylenediamine, undecamethylenediamine, dodecamethylenediamine, 2-methylpentamethylenediamine, 2,2,4-trimethylhexamethylenediamine, 2,4,4-trimethylhexamethylenediamine, 5-methylnonamethylenediamine, 2,4-dimethyloctamethylenediamine, 5-methylnonanediamine, bis(4-aminocyclohexyl)methane, 3,3′-dimethyl-4,4′-diaminodicyclohexylmethane and mixtures thereof.

The diamine pD) is particularly preferably selected from hexamethylenediamine, 2-methylpentamethylenediamine, octamethylenediamine, nonamethylenediamine, 2-methyl-1,8-octamethylenediamine, decamethylenediamine, undecamethylenediamine, dodecamethylenediamine, bis(4-aminocyclohexyl)methane, 3,3′-dimethyl-4,4′-diaminodicyclohexylmethane and mixtures thereof.

In a specific embodiment the semiaromatic polyamides comprise at least one copolymerized diamine pD) selected from hexamethylenediamine, bis(4-aminocyclohexyl)methane (PACM), 3,3′-dimethyl-4,4′-diaminodicyclohexylmethane (MACM), isophoronediamine (IPDA) and mixtures thereof.

In a specific embodiment the semiaromatic polyamides comprise exclusively hexamethylenediamine as the copolymerized diamine pD).

In a further specific embodiment the semiaromatic polyamides comprise exclusively bis(4-aminocyclohexyl)methane as the copolymerized diamine pD).

In a further specific embodiment the semiaromatic polyamides comprise exclusively 3,3′-dimethyl-4,4′-diaminodicyclohexylmethane (MACM) as the copolymerized diamine pD).

In a further specific embodiment the semiaromatic polyamides comprise exclusively isophoronediamine (IPDA) as the copolymerized diamine pD).

The aliphatic and the semiaromatic polyamides may comprise at least one copolymerized monocarboxylic acid pE). The monocarboxylic acids pE) serve to end-cap the polyamides produced according to the invention. Suitable monocarboxylic acids are in principle all of those capable of reacting with at least some of the amino groups available under the reaction conditions of the polyamide condensation. Suitable monocarboxylic acids pE) are aliphatic monocarboxylic acids, alicyclic monocarboxylic acids and aromatic monocarboxylic acids. These include acetic acid, propionic acid, n-, iso- or tert-butyric acid, valeric acid, tri-methylacetic acid, caproic acid, enanthic acid, caprylic acid, pelargonic acid, capric acid, un-decanoic acid, lauric acid, tridecanoic acid, myristic acid, palmitic acid, stearic acid, pivalic acid, cyclohexanecarboxylic acid, benzoic acid, methylbenzoic acids, α-naphthalenecarboxylic acid, β-naphthalenecarboxylic acid, phenylacetic acid, oleic acid, ricinoleic acid, linoleic acid, linolenic acid, erucic acid, fatty acids from soya, linseeds, castor oil plants and sun-flowers, acrylic acid, methacrylic acid, Versatic® acids, Koch® acids and mixtures thereof.

If the monocarboxylic acids pE) employed are unsaturated carboxylic acids or derivatives thereof it may be advantageous to operate in the presence of commercial polymerization inhibitors.

It is particularly preferable when the monocarboxylic acid pE) is selected from acetic acid, propionic acid, benzoic acid and mixtures thereof.

In a specific embodiment the aliphatic and the semiaromatic polyamides comprise exclusively propionic acid as the copolymerized monocarboxylic acid pE).

In a further specific embodiment the aliphatic and the semiaromatic polyamides comprise exclusively benzoic acid as the copolymerized monocarboxylic acid pE).

In a further specific embodiment the aliphatic and the semiaromatic polyamides comprise exclusively acetic acid as the copolymerized monocarboxylic acid pE).

The aliphatic and the semiaromatic polyamides may comprise at least one copolymerized monoamine pF). The aliphatic polyamides then comprise only copolymerized aliphatic monoamines or alicyclic monoamines. The monoamines pF) serve to end-cap the polyamides produced according to the invention. Suitable monoamines are in principle all of those capable of reacting with at least some of the carboxylic acid groups available under the reaction conditions of the polyamide condensation. Suitable monoamines pF) are aliphatic monoamines, alicyclic monoamines and aromatic monoamines. These include methylamine, ethylamine, propylamine, butylamine, hexylamine, heptylamine, octylamine, decylamine, stearylamine, dimethylamine, diethylamine, dipropylamine, dibutylamine, cyclohexylamine, dicyclohexylamine, aniline, toluidine, diphenylamine, naphthylamine and mixtures thereof.

At least one at least trivalent amine pG) may additionally be used to produce the aliphatic and the semiaromatic polyamides. These include N′-(6-aminohexyl)hexane-1,6-diamine, N′-(12-aminododecyl)dodecane-1,12-diamine, N′-(6-aminohexyl)dodecane-1,12-diamine, N′-[3-(aminomethyl)-3,5,5-trimethylcyclohexyl]hexane-1,6-diamine, N′-[3-(aminomethyl)-3,5,5-trimethylcyclohexyl]dodecane-1,12-diamine, N′-[(5-amino-1,3,3-trimethylcyclo-hexyl)methyl]hexane-1,6-diamine, N′-[(5-amino-1,3,3-trimethylcyclohexyl)methyl]dodec-ane-1,12-diamine, 3-[[[3-(aminomethyl)-3,5,5-trimethylcyclohexyl]amino]methyl]-3,5,5-trimethylcyclohexanamine, 3-[[(5-amino-1,3,3-trimethylcyclohexyl)methylamino]methyl]-3,5,5-trimethylcyclohexanamine, 3-(aminomethyl)-N-[3-(aminomethyl)-3,5,5-trimethylcyclo-hexyl]-3,5,5-trimethylcyclohexanamine. It is preferable when no at least trifunctional amines pG) are used.

Suitable lactams pH) are ε-caprolactam, 2-piperidone (δ-valerolactam), 2-pyrrolidone (y-butyrolactam), capryllactam, enantholactam, lauryllactam and mixtures thereof.

Suitable ω-amino acids pI) are 6-aminocaproic acid, 7-aminoheptanoic acid, 11-aminoundecanoic acid, 12-aminododecanoic acid and mixtures thereof.

Suitable compounds pK) distinct from and co-condensable with pA) to pI) are at least tribasic carboxylic acids, diaminocarboxylic acids, etc.

Suitable compounds pK) further include 4-[(Z)-N-(6-aminohexyl)-C-hydroxycarbonimidoyl]benzoic acid, 3-[(Z)-N-(6-aminohexyl)-C-hydroxycarbonimidoyl]benzoic acid, (6Z)-6-(6-aminohexylimino)-6-hydroxyhexanecarboxylic acid, 4-[(Z)-N-[(5-amino-1,3,3-trimethylcyclohexyl)methyl]-C-hydroxycarbonimidoyl]benzoic acid, 3-[(Z)-N-[(5-amino-1,3,3-tri-methylcyclohexyl)methyl]-C-hydroxycarbonimidoyl]benzoic acid, 4-[(Z)-N-[3-(aminome-thyl)-3,5,5-trimethylcyclohexyl]-C-hydroxycarbonimidoyl]benzoic acid, 3-[(Z)-N-[3-(aminomethyl)-3,5,5-trimethylcyclohexyl]-C-hydroxycarbonimidoyl]benzoic acid and mixtures thereof.

The polyamide A is preferably selected from PA 4, PA 5, PA 6, PA 7, PA 8, PA 9, PA 10, PA 11, PA 12, PA 46, PA 66, PA 666, PA 69, PA 610, PA 612, PA 96, PA 99, PA 910, PA 912, PA 1212, PA 6.T, PA 9.T, PA 8.T, PA 10.T, PA 12.T, PA 6.1, PA 8.1, PA 9.1, PA 10.1, PA 12.1, PA 6.T/6, PA 6.T/10, PA 6.T/12, PA 6.T/6.1, PA6.T/8.T, PA 6.T/9.T, PA 6.T/10T, PA 6.T/12.T, PA 12.T/6.T, PA 6.T/6.1/6, PA 6.T/6.1/12, PA 6.T/6.1/6.10, PA 6.T/6.1/6.12, PA 6.T/6.6, PA 6.T/6.10, PA 6.T/6.12, PA 10.T/6, PA 10.T/11, PA 10.T/12, PA 8.T/6.T, PA 8.T/66, PA 8.T/8.1, PA 8.T/8.6, PA 8.T/6.1, PA 10.T/6.T, PA 10.T/6.6, PA 10.T/10.1, PA 10T/10.1/6.T, PA 10.T/6.1, PA 4.T/4.1/46, PA 4.T/4.1/6.6, PA 5.T/5.1, PA 5.T/5.1/5.6, PA 5.T/5.1/6.6, PA 6.T/6.1/6.6, PA MXDA.6, PA IPDA.I, PA IPDA.T, PA MACM.I, PA MACM.T, PA PACM.I, PA PACM.T, PA MXDA.I, PA MXDA.T, PA 6.T/IPDA.T, PA 6.T/MACM.T, PA 6.T/PACM.T, PA 6.T/MXDA.T, PA 6.T/6.1/8.T/8.1, PA 6.T/6.1/10.T/10.1, PA 6.T/6.1/IPDA.T/IPDA.1, PA 6.T/6.1/MXDA.T/MXDA.1, PA 6.T/6.1/MACM.T/MACM.1, PA 6.T/6.1/PACM.T/PACM.1, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T and copolymers and mixtures thereof.

In a preferred embodiment the polyamide composition employed in accordance with the invention comprises at least one aliphatic polyamide as component A) or consists of aliphatic polyamide.

The aliphatic polyamide is then preferably selected from PA 4, PA 5, PA 6, PA 7, PA 8, PA 9, PA 10, PA 11, PA 12, PA 46, PA 66, PA 666, PA 69, PA 610, PA 612, PA 96, PA 99, PA 910, PA 912, PA 1212 and copolymers and mixtures thereof.

The aliphatic polyamide A) is in particular selected from PA 6, PA 66 or PA 12. One specific embodiment is that of polyamide compositions in which the component A) comprises PA 6 or PA 66 or consists of PA 6, PA 66 or mixtures thereof.

A semiaromatic polyamide/copolyamide is preferably selected from PA 6.T, PA 9.T, PA 10.T, PA 12.T, PA 6.1, PA 9.1, PA 10.1, PA 12.1, PA 6.T/6.1, PA 6.T/6, PA6.T/8.T, PA 6.T/10T, PA 10.T/6.T, PA 6.T/12.T, PA 12.T/6.T, PA IPDA.I, PA IPDA.T, PA 6.T/IPDA.T, PA 6.T/6.1/IPDA.T/IPDA.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T and copolymers and mixtures thereof.

In the context of the present invention the number-average molecular weights Mₙ and weight-average molecular weights M_{W} which follow are based on a determination by gel permeation chromatography (GPC). Calibration was performed using for example PMMA as the polymer standard having a low polydispersity.

The synthetic polyamide A) preferably has a number-average molecular weight Mₙ in a range from 8000 to 50 000 g/mol, particularly preferably from 10 000 to 35 000 g/mol.

The synthetic polyamide A) preferably has a weight-average molecular weight Mₙ in a range from 15 000 to 200 000 g/mol, particularly preferably from 20 000 to 125 000 g/mol.

The polyamides preferably have a polydispersity PD (=M_{W}/Mₙ) of not more than 6, particularly preferably of not more than 5, especially of not more than 3.5.

The present invention also relates to the use of special polyamide compositions based on aliphatic polyamides and copolyamides/terpolyamides. When using a polyamide mixture of aliphatic polyamide A1) and aliphatic copolyamide or terpolyamide A2) the weight ratio of A1) to A2) is preferably 55:45 to 95:5. The polyamide mixture then forms the component A).

In the polyamide compositions employed according to the invention the polyamide mixture A) then comprises aliphatic polyamide A1) and aliphatic copolyamide or terpolyamide A2).

The corresponding components may be selected from the components recited hereinabove.

The aliphatic polyamide A1) is preferably selected from: PA 4, PA 5, PA 6, PA 7, PA 8, PA 9, PA 10, PA 11, PA 12, PA 46, PA 66, PA 69, PA 610, PA 612, PA 96, PA 99, PA 910, PA 912, PA 1212.

The aliphatic polyamide A1) is particularly preferably selected from polyamide 6, polyamide 66 and mixtures thereof.

The aliphatic copolyamide or terpolyamide A2) is preferably constructed from the monomers of two or three polyamides selected from PA 4, PA 5, PA 6, PA 7, PA 8, PA 9, PA 10, PA 11, PA 12, PA 46, PA 66, PA 69, PA 610, PA 612, PA 96, PA 99, PA 910, PA 912, PA 1212.

Specific examples of copolyamides are PA 66/6, PA 66/68, PA 66/610, PA 66/612, PA 66/10, PA 66/12, PA 6/68, PA 6/610, PA 6/612, PA 6/10, PA 6/12. Examples of suitable terpolymers are PA 6/66/610, PA 6/66/69, PA 6/66/11, PA 6/66/12, PA 6/610/11, PA 6/610/12, 6/66/PACM.

The aliphatic copolyamide is preferably a PA 6/PA 66 copolymer.

Suitable aliphatic polyamides and copolyamides/terpolyamides are additionally recited in EP-1B-1 060 216.

The weight ratio of aliphatic polyamide A1) to aliphatic copolyamide or terpolyamide A2) is 55:45 to 95:5, preferably 60:40 to 90:10, especially 70:30 to 90:10.

The crystallization point (crystallization temperature) of the polyamide mixture A) should preferably be below the crystallization points (crystallization temperatures) of the aliphatic polyamide A1) and the aliphatic copolyamide/terpolyamide A2). In the use according to the invention and the process according to the invention too the crystallization point of the mixture of the at least one polyamide and at least one copolyamide or terpolyamide should preferably be below the crystallization points of the at least one polyamide and the at least one copolyamide or terpolyamide.

The addition of the copolyamide/terpolyamide thus preferably has the effect of reducing the crystallization point in the polyamide composition. The reduction or lowering of the crystallization point may be determined by DSC measurement (differential scanning calorimetry).

The polyamide compositions according to the invention optionally comprise glass fibers as component B). When glass fibers are present the maximum permissible amount of component A) is reduced by the minimum amount of glass fibers present.

Specifically, chopped glass fibers are used. The component B) especially comprises glass fibers, it being preferable to employ short fibers. These preferably have a length in the range from 2 to 50 mm and a diameter of 5 to 40 μm. It is alternatively possible to use continuous fibers (rovings). Suitable fibers include those having a circular and/or noncircular cross-sectional area, wherein in the latter case the dimensional ratio of the main cross-sectional axis to the secondary cross-sectional axis is especially>2, preferably in the range from 2 to 8 and particularly preferably in the range from 3 to 5.

In a specific embodiment component B) comprises so-called “flat glass fibers”. These specifically have an oval or elliptical cross-sectional area or a necked elliptical (so-called “cocoon” fibers) or rectangular or virtually rectangular cross-sectional area. Preference is given here to using glass fibers with a noncircular cross-sectional area and a dimensional ratio of the main cross-sectional axis to the secondary cross-sectional axis of more than 2, preferably of 2 to 8, in particular of 3 to 5.

Reinforcement of the molding materials according to the invention may also be effected using mixtures of glass fibers having circular and noncircular cross sections. In a specific embodiment the proportion of flat glass fibers, as defined above, predominates, i.e. they account for more than 50% by weight of the total mass of the fibers.

When rovings of glass fibers are used as component B) said fibers preferably have a diameter of 10 to 20 μm, preferably of 12 to 18 μm. The cross section of these glass fibers may be round, oval, elliptical, virtually rectangular or rectangular. So-called flat glass fibers having a ratio of the cross-sectional axes of 2 to 5 are particularly preferred. E glass fibers are used in particular. However, it is also possible to use any other glass fiber types, for example A, C, D, M, S or R glass fibers, or any desired mixtures thereof or mixtures with E glass fibers.

The polyamide molding materials according to the invention can be produced by the known processes for producing long fiber-reinforced rod pellets, especially by pultrusion processes, in which the continuous fiber strand (roving) is fully saturated with the polymer melt and then cooled and chopped. The long fiber-reinforced rod pellets obtained in this manner, which preferably have a pellet length of 3 to 25 mm, especially of 4 to 12 mm, may be processed further to afford moldings by the customary processing methods, for example injection molding or press molding.

The polyamide compositions according to the invention optionally comprise one or more heat stabilizers as component C).

As component C) the molding materials according to the invention may comprise preferably 0.01% to 2% by weight, particularly preferably 0.02% to 1% by weight, in particular 0.05% to 0.5% by weight, of at least one heat stabilizer based on the total weight of the composition.

The heat stabilizers are preferably selected from copper compounds, secondary aromatic amines, sterically hindered phenols, phosphites, phosphonites and mixtures thereof.

If a copper compound is used the amount of copper is preferably 0.003% to 0.5% by weight, in particular 0.005% to 0.3% by weight and particularly preferably 0.01% to 0.2% by weight based on the total weight of the composition.

If stabilizers based on secondary aromatic amines are used the amount of these stabilizers is preferably 0.2% to 2% by weight, particularly preferably 0.2% to 1.5% by weight, based on the total weight of the composition.

If stabilizers based on sterically hindered phenols are used the amount of these stabilizers is preferably 0.07% to 1.5% by weight, particularly preferably 0.1% to 1% by weight, based on the total weight of the composition.

If stabilizers based on phosphites and/or phosphonites are used the amount of these stabilizers is preferably 0.1% to 1.5% by weight, particularly preferably from 0.2% to 1% by weight, based on the total weight of the composition.

Suitable compounds C) of mono- or divalent copper are, for example, salts of mono- or divalent copper with inorganic or organic acids or mono- or dihydric phenols, the oxides of mono- or divalent copper or the complexes of copper salts with ammonia, amines, amides, lactams, cyanides or phosphines, preferably Cu(I) or Cu(II) salts of the hydrohalic acids or of the hydrocyanic acids or the copper salts of the aliphatic carboxylic acids. Particular preference is given to the monovalent copper compounds CuCl, CuBr, Cul, CuCN and Cu₂0 and to the divalent copper compounds CuCl₂, CuSO₄, CuO, copper(II) acetate or copper(II) stearate.

The copper compounds are commercially available and/or the production thereof is known to those skilled in the art. The copper compound may be used as such or in the form of concentrates. A concentrate is to be understood as meaning a polymer, preferably of the same chemical nature as component A), comprising the copper salt in a high concentration. The use of concentrates is a customary process and is particularly often employed when very small amounts of an input material are to be added. It is advantageous to employ the copper compounds in combination with further metal halides, in particular alkali metal halides, such as Nal, KI, NaBr, KBr, wherein the molar ratio of metal halide to copper halide is 0.5 to 20, preferably 1 to 10 and particularly preferably 3 to 7.

Particularly preferred examples of stabilizers which are based on secondary aromatic amines and are usable in accordance with the invention include adducts of phenylenediamine with acetone (Naugard® A), adducts of phenylenediamine with linolenic acid, 4,4′-bis(α, α-dimethylbenzyl)diphenylamine (Naugard® 445), N,N′-dinaphthyl-p-phenylenediamine, N-phenyl-N′-cyclohexyl-p-phenylenediamine or mixtures of two or more thereof.

Preferred examples of stabilizers employable according to the invention and based on sterically hindered phenols include N,N′-hexamethylenebis-3-(3,5-di-tert-butyl-4-hydroxy-phenyl)propionamide (Irganox® 1098), bis(3,3-bis(4′-hydroxy-3′-tert-butylphenyl)butanoic acid) glycol ester, 2,1′-thioethyl bis(3-(3,5-di-tert-butyl-4-hydroxyphenyl))propionate, 4,4′-butylidenebis(3-methyl-6-tert-butylphenol), triethylene glycol 3-(3-tert-butyl-4-hydroxy-5-methylphenyl)propionate or mixtures of two or more of these stabilizers.

Preferred phosphites and phosphonites are triphenyl phosphite, diphenyl alkyl phosphite, phenyl dialkyl phosphite, tris(nonylphenyl) phosphite, trilauryl phosphite, trioctadecyl phosphite, distearyl pentaerythrityl diphosphite, tris(2,4-di-tert-butylphenyl) phosphite, diisodecyl pentaerythrityl diphosphite, bis(2,4-di-tert-butylphenyl) pentaerythrityl diphosphite, bis(2,6-di-tert-butyl-4-methylphenyl) pentaerythrityl diphosphite, diisodecyloxy pentaerythrityl diphosphite, bis(2,4-di-tert-butyl-6-methylphenyl) pentaerythrityl diphosphite, bis(2,4,6-tris(tert-butylphenyl)) pentaerythrityl diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo-[d,g]-1,3,2-dioxaphosphocin, 6-fluoro-2,4,8,10-tetra-tert-bu-tyl-12-methyldibenzo-[d,g]-1,3,2-dioxaphosphocin, bis(2,4-di-tert-butyl-6-methylphenyl)methyl phosphite and bis(2,4-di-tert-butyl-6-methylphenyl) ethyl phosphite.

Preference is given in particular to tris[2-tert-butyl-4-thio(2′-methyl-4′-hydroxy-5′-tert-butyl)phenyl-5-methyl]phenyl phosphite and tris(2,4-di-tert-butylphenyl) phosphite (Hostanox® PAR24: commercially available from BASF SE).

A preferred embodiment of the heat stabilizer consists in the combination of organic heat stabilizers (especially Hostanox® PAR 24 and Irganox® 1010), a bisphenol A-based epoxide (especially Epikote® 1001) and copper stabilization based on Cul and KI. An example of a commercially available stabilizer mixture consisting of organic stabilizers and epoxides is Irgatec® NC66 from BASF SE. Heat stabilization based exclusively on Cul and KI is especially preferred. Aside from the addition of copper or copper compounds, the use of further transition metal compounds, especially metal salts or metal oxides of group VB, VIB, VIIB or VIIIB of the Periodic Table, is ruled out. In addition, it is preferable not to add any transition metals of group VB, VIB, VIIB or VIIIB of the Periodic Table, for example iron powder or steel powder, to the molding material according to the invention. The use of Irganox® 1098 is also particularly preferred.

The use of copper compounds, especially monovalent copper compounds, and stabilizers based on sterically hindered phenols, such as Irganox® 1098, and mixtures thereof is especially preferred. The especially preferred usage amount is in the range from 0.05% to 0.5% by weight, especially 0.07% to 0.2% by weight.

At least one polyhydric alcohol having more than two hydroxyl groups is employed as component D). Such polyols are described for example in WO 2010/014801, see in particular page 14, line 29 to page 16, line 7 therein.

The polyhydric alcohols may be selected from aliphatic hydroxyl compounds having more than two hydroxyl groups, aliphatic-cycloaliphatic compounds having more than two hydroxyl groups, cycloaliphatic compounds having more than two hydroxyl groups, aromatic compounds and saccharides.

An aliphatic chain in polyhydric alcohols may comprise not only carbon but also heteroatoms, such as nitrogen, oxygen or sulfur atoms. A cycloaliphatic ring in the polyhydric alcohol may be a monocycle or part of a dicyclic or polycyclic ring system. It may be carbocyclic or heterocyclic. The polyhydric alcohols may comprise one or more substituents, such as ether, carboxylic acid, carboxamide, or carboxylic ester groups or may be polyvinyl alcohol copolymers, for example ethylene vinyl alcohol copolymers. These copolymers ideally have an MFR (210° C./2.16 kg) of between 2 and 20 g/10 min.

Examples of suitable polyhydric alcohols, preferably having a number-average molecular weight (M) of less than 2000, are triols, such as glycerol, trimethylolpropane, 2,3-di-(2′-hy-droxyethyl)cyclohexan-1-ol, hexane-1,2,6-triol, 1,1,1-tris(hydroxymethyl)ethane, 3-(2′-hy-droxyethoxy)propane-1,2-diol, 3-(2′-hydroxypropoxy)propane-1,2-diol, 2-(2′-hydroxyeth-oxy)hexane-1,2-diol, 6-(2′-hydroxypropoxy)hexane-1,2-diol, 1,1,1-tris[(2′-hydroxyeth-oxy)methyl]ethane, 1,1,1-tris[(2′-hydroxypropoxy)methyl]propane, 1,1,1-tris(4′-hydroxy-phenyl)ethane, 1,1,1-tris(hydroxyphenyl)propane, 1,1,3-tris(dihydroxy-3-methylphenyl)propane, 1,1,4-tris(dihydroxyphenyl)butane, 1,1,5-tris(hydroxyphenyl)-3-methylpentane, ditrimethylopropane, trimethylolpropane ethoxylates or trimethylolpropane propoxylates, polyols, such as pentaerythritol, dipentaerythritol and tripentaerythritol, and saccharides, such as cyclodextrin, D-mannose, glucose, galactose, sucrose, fructose, xylose, arabinose, D-mannitol, D-sorbitol, D- or L-arabitol, xylitol, iditol, talitol, allitol, altritol, guilitol, erythritol, threitol and D-gulono-γ-lactone.

In preferred polyhydric alcohols the hydroxyl groups are each bonded to carbon atoms separated from one another by at least one atom, preferably a carbon atom. Accordingly the polyhydric alcohol is preferably pentaerythritol, dipentaerythritol, tripentaerythritol, trimethylolpropane, D-mannitol, D-sorbitol or xylitol. It is particularly preferable when the polyhydric alcohol is dipentaerythritol and/or tripentaerythritol. Dipentaerythritol is most preferred.

The polyamide compositions may comprise further additives as component E). If component E) is co-used the upper limit for the component A) is reduced correspondingly.

As component E) the compositions according to the invention comprise 0% to 20% by weight, preferably 0% to 10% by weight and in particular 0% to 5% by weight of further additives. If such additives are co-used the minimum amount is 0.1% by weight, preferably 1% by weight, in particular 3% by weight.

If component E) is co-used the upper limit for the component A) is reduced correspondingly.

Thus, at a minimum amount of 0.1% by weight of the component E) the upper limit for the amount of component A) is 89.88% by weight for example.

Contemplated further additives include fillers and reinforcers distinct from glass fibers, thermoplastic polymers distinct from component A) or other additives.

In the context of the invention the term “filler and reinforcer” (=possible component E)) is to be interpreted broadly and comprises particulate fillers, fibrous substances and any intermediate forms. Particulate fillers may have a wide range of particle sizes ranging from particles in the form of dusts to large grains. Contemplated filler materials include organic or inorganic fillers and reinforcers. Employable here are for example inorganic fillers, such as kaolin, chalk, wollastonite, talc, calcium carbonate, silicates, titanium dioxide, zinc oxide, graphite, glass particles, for example glass spheres, nanoscale fillers, such as carbon nano-tubes, nanoscale sheet silicates, nanoscale alumina (Al₂O₃), nanoscale titanium dioxide (TiO₂), graphene, permanently magnetic or magnetizable metal compounds and/or alloys, phyllosilicates and nanoscale silicon dioxide (SiO₂). The fillers may also have been surface treated.

Examples of phyllosilicates usable in the molding materials according to the invention include kaolins, serpentines, talc, mica, vermiculites, illites, smectites, montmorillonite, hectorite, double hydroxides or mixtures thereof. The phyllosilicates may have been surface treated or may be untreated.

One or more fibrous substances may also be employed. These are preferably selected from known inorganic reinforcing fibers, such as boron fibers, carbon fibers, silica fibers, ceramic fibers and basalt fibers; organic reinforcing fibers, such as aramid fibers, polyester fibers, nylon fibers, polyethylene fibers and natural fibers, such as wood fibers, flax fibers, hemp fibers and sisal fibers.

It is especially preferable to employ carbon fibers, aramid fibers, boron fibers, metal fibers or potassium titanate fibers.

The thermoplastic polymers distinct from component A) are preferably selected from
homo- or copolymers which comprise in copolymerized form at least one monomer selected from C₂-C₁₀-monoolefins, for example ethylene or propylene, 1,3-butadiene, 2-chloro-1,3-butadiene, vinyl chloride, vinylidene chloride, vinylidene fluoride, tetrafluoro-ethylene, glycidyl acrylate, glycidyl methacrylate, acrylates and methacrylates having alcohol components of branched and unbranched C₁-C₁₀-alcohols, vinylaromatics, for example styrene, acrylonitrile, methacrylonitrile, a, #-ethylenically unsaturated mono- and dicarboxylic acids, and maleic anhydride;
homo- and copolymers of vinyl acetals,
polyvinyl esters,
polyvinylpyrrolidone or polyvinylpyrrolidone copolymers (PVP),
polycarbonates (PC),
polyesters, such as polyalkylene terephthalates, polyhydroxyalkanoates (PHA), polybutylene succinates (PBS), polybutylene succinate adipates (PBSA),
polyethers,
polyether ketones,
thermoplastic polyurethanes (TPU),
polysulfides,
polysulfones,
polyether sulfones,
cellulose alkyl esters and mixtures thereof.

Examples include polyacrylates having identical or different alcohol radicals from the group of C₄-C$ alcohols, particularly of butanol, hexanol, octanol and 2-ethylhexanol, polymethyl-methacrylate (PMMA), methyl methacrylate-butyl acrylate copolymers, acrylonitrile-butadi-ene-styrene copolymers (ABS), ethylene-propylene copolymers, ethylene-propylene-diene copolymers (EPDM), polystyrene (PS), styrene-acrylonitrile copolymers (SAN), acrylonitrile-styrene-acrylate (ASA), styrene-butadiene-methyl methacrylate copolymers (SBMMA), sty-renemaleic anhydride copolymers, styrene-methacrylic acid copolymers (SMA), polyoxymethylene (POM), polyvinyl alcohol (PVAL), polyvinyl acetate (PVA), polyvinyl butyral (PVB), polycaprolactone (PCL), polyhydroxybutyric acid (PHB), polyhydroxyvaleric acid (PHV), polylactic acid (PLA), ethyl cellulose (EC), cellulose acetate (CA), cellulose propionate (CP) or cellulose acetate/butyrate (CAB).

The at least one thermoplastic polymer present in the molding material according to the invention is preferably polyvinyl chloride (PVC), polyvinyl butyral (PVB), homo- and copolymers of vinyl acetate, homo- and copolymers of styrene, polyacrylates, thermoplastic polyurethanes (TPUs) or polysulfides.

It may be advantageous to use nigrosin (Solvent Black 7, CAS No. 8005-02-5) and/or Solvent Black 28 (CAS No. 12237-23-91) optionally combined with at least one further colorant.

Component E) is then preferably selected from non-nucleating colorants distinct from C).

These include non-nucleating dyes, non-nucleating pigments and mixtures thereof. Examples of non-nucleating dyes are Solvent Yellow 21 (commercially available as Oracet® Yellow 160 FA from BASF SE) or Solvent Blue 104 (commercially available as Solvaperm® Blue 2B from Clariant). Examples of non-nucleating pigments are Pigment Brown 24 (commercially available as Sicotan® Yellow K 2011 FG from BASF SE). Also useful as component E) are small amounts of at least one white pigment. Suitable white pigments are titanium dioxide (Pigment White 6), barium sulfate (Pigment White 22), zinc sulfide (Pigment White 7) etc. In a specific embodiment the molding material according to the invention comprises 0.001% to 0.5% by weight of at least one white pigment as component E). For example, the molding material may comprise 0.05% by weight of Kronos 2220 titanium dioxide from Kronos.

The manner and amount of the addition is guided by the hue, i.e. the desired shade of the black color. For example, with Solvent Yellow 21, it is possible to move the hue of the black color in the CIELAB color space from, for example, b*=−1.0 in the direction of +b*, i.e. in the yellow direction. This method is known to those skilled in the art as color shading.

Measurement is effected in accordance with DIN 6174 “Colorimetric evaluation of colour coordinates and colour differences according to the approximately uniform CIELAB colour space” or the successor standard.

Co-use of carbon black as component E) is also possible. The compositions according to the invention comprise for example 0.01% to 1% by weight, preferably 0.03% to 0.5% by weight, in particular 0.05% to 0.3% by weight, of carbon black. Carbon black, also known as industrial carbon black, is a modification of carbon with a high surface-to-volume ratio and consists of 80% to 99.5% by weight of carbon. The specific surface area of industrial carbon black is about 10 to 1500 m²/g (BET). The carbon black may have been produced in the form of channel black, furnace black, flame black, cracking black or acetylene black. The particle diameter is in the range from 8 to 500 nm, typically 8 to 110 nm. Carbon black is also referred to as pigment black 7 or lamp black 6. Color blacks are nanoparticulate carbon blacks that, due to their fineness, increasingly lose the brown base hue of conventional carbon blacks.

Suitable preferred additives E) are lubricants, flame retardants, light stabilizers (UV stabilizers, UV absorbers or UV blockers), dyes, nucleating agents, metallic pigments, metal flakes, metal-coated particles, antistats, conductivity additives, demolding agents, optical brighteners, defoamers, etc.

The molding materials according to the invention preferably comprise 0% to 15% by weight, particularly preferably 0% to 10% by weight, based on the total weight of the composition of at least one flame retardant as additive E). When the inventive molding materials comprise at least one flame retardant, preferably in an amount of 0.01 to 15% by weight, particularly preferably of 0.1 to 10% by weight, based on the total weight of the composition. Suitable flame retardants include halogen-containing and halogen-free flame retardants and synergists thereof (see also Gschter/Müller, 3rd edition 1989 Hanser Verlag, chapter 11). Preferred halogen-free flame retardants are red phosphorus, phosphinic or diphosphinic salts and/or nitrogen-containing flame retardants such as melamine, melamine cyanurate, melamine sulfate, melamine borate, melamine oxalate, melamine phosphate (primary, secondary) or secondary melamine pyrophosphate, neopentyl glycol boric acid melamine, guani-dine and derivatives thereof known to those skilled in the art, and also polymeric melamine phosphate (CAS No.: 56386-64-2 or 218768-84-4 and also EP-A-1 095 030), ammonium polyphosphate, trishydroxyethyl isocyanurate (optionally also ammonium polyphosphate in ad-mixture with trishydroxyethyl isocyanurate) (EP-A-058 456 7). Further N-containing or P-containing flame retardants or PN condensates suitable as flame retardants, as well as the synergists customary therefor such as oxides or borates, may be found in DE-A-10 2004 049 342. Suitable halogenated flame retardants are for example oligomeric brominated polycarbonates (BC 52 Great Lakes) or polypentabromobenzyl acrylates with N greater than 4 (FR 1025 Dead sea bromine), reaction products of tetrabromobisphenol A with epoxides, brominated oligomeric or polymeric styrenes, dechlorane, which are usually used with antimony oxides as synergists (for details and further flame retardants see DE-A-10 2004 050 025).

The polyamide molding materials are produced by processes known per se. These include the mixing of the components in the appropriate proportions by weight. The mixing of the components is preferably accomplished at elevated temperatures by commixing, blending, kneading, extruding or rolling. The temperature during mixing is preferably in a range from 220° C. to 340° C., particularly preferably from 240° C. to 320° C. and especially from 250° C. to 300° C. Suitable processes are known to those skilled in the art.

Shaped Articles

The polyamide compositions employed according to the invention are used to produce shaped articles by injection molding, wherein during injection molding at least two flow fronts of the molten polyamide composition collide and form at least one weld seam.

The shaped articles thus have at least one weld seam arising from the injection molding process. The injection molding may be carried out according to known processes and is described for example in “Einfsrben von Kunststoffen”, VDI-Verlag, ISBN 3-18-404014-3. At least two injection points are typically provided in the mold in injection molding, thus resulting in the at least two flow fronts of the molten polyamide composition. Depending on the size and shape of the shaped article many more injection points may also be provided.

The at least two flow fronts may also form through flow around a cavity or core in the mold.

The shaped articles produced according to the invention may be one-part or multi-part articles. In the case of a multi-part construction the individual shaped articles must be joined to one another subsequently, for example through welding, such as friction welding, hot gas welding or laser transmission welding.

The polyamide shaped articles obtainable by the process according to the invention are further advantageously suitable for use in automotive applications, for electrical and electronic components, especially also in the high-temperature sector.

A specific embodiment is that of shaped articles in the form of or as part of a component part for the automotive sector, especially selected from cylinder head covers, engine covers, housings for charge air coolers, charge air cooler valves, intake pipes, intake manifolds, connectors, gears, fan impellers, cooling water tanks, housings or housing parts for heat ex-changers, coolant coolers, charge air coolers, thermostats, water pumps, heating elements, securing parts.

Possible uses in automobile interiors are for dashboards, steering-column switches, seat components, headrests, center consoles, gearbox components and door modules, and possible uses in automobile exteriors are for A, B, C, or D pillar covers, spoilers, door handles, exterior mirror components, windshield wiper components, windshield wiper protective housings, decorative grilles, cover strips, roof rails, window frames, sunroof frames, antenna covers, front and rear lights, engine hoods, cylinder head covers, intake pipes, windshield wipers, and exterior bodywork parts.

A further specific embodiment is that of shaped articles as such or as part of an electrical or electronic passive or active component, of a printed circuit board, of part of a printed circuit board, of a housing constituent, of a film, or of a wire, more particularly in the form of or as part of a switch, of a plug, of a bushing, of a distributor, of a relay, of a resistor, of a capaci-tor, of a winding or of a winding body, of a lamp, of a diode, of an LED, of a transistor, of a connector, of a regulator, of an integrated circuit (IC), of a processor, of a controller, of a memory element and/or of a sensor.

Possible uses of the polyamides for the kitchen and household sector are for producing components for kitchen machines, for example fryers, clothes irons, knobs and buttons, and also applications in the gardens sector, for example components for irrigation systems or garden equipment.

Production of the polyamide composition for producing shaped articles is carried out by processes known per se. Reference is made here to the abovementioned processes for producing the polyamide composition. These include the mixing of the components in the appropriate proportions by weight. The mixing of the components is preferably accomplished at elevated temperatures by commixing, blending, kneading, extruding or rolling. The temperature during mixing is preferably in a range from 220° C. to 340° C., particularly preferably from 240° C. to 320° C. and especially from 250° C. to 300° C. Premixing of individual components may be advantageous. It is further also possible to produce the moldings di-rectly from a physical mixture (dryblend) of premixed components and/or individual components which has been produced well below the melting point of the polyamide. In that case the temperature during the mixing is preferably 0° C. to 100° C., particularly preferably 10° C. to 50° C., in particular ambient temperature (250° C.). The molding materials are processed into shaped articles by injection molding. Said materials are especially suitable, for example, for materials for covers, housings, accessory parts, sensors, for applications in, for example, the automotive, electrical engineering, electronics, telecommunications, information technology, computer, household, sports, medical, or entertainment sectors.

The shaped articles produced from the polyamide compositions employed according to the invention by injection molding exhibit a markedly elevated weld seam strength after thermal aging over a wide temperature range, especially after thermal aging at 180° C. for 500 hours. The tensile strength of the shaped articles and especially of the weld seam is largely retained or only slightly reduced upon heat treatment for 500 hours at 180° C.

Thermal aging is carried out in this case analogously to commonly used specifications from the automobile industry.

It is thus possible through the use of the described polyamide molding materials, especially upon co-use of the copolyamides/terpolyamides, to significantly improve the weld seam strength after oxidative and thermal aging. The disadvantages of the molding materials described in WO 2010/014801 and EP-B-2 307 480 for relevant applications can thus be overcome.

The invention is more particularly elucidated by the following examples.

### EXAMPLES

The following input materials were used:
A1: Polyamide 6: Ultramid® B27 from BASF SE, melting point: 222° C., viscosity number (0.5% in 96% H₂SO₄): 150 cm³/g. The viscosity number of the polyamide was determined at 25° C. in accordance with ISO 307.
B: Glass fiber: OCV-995, manufacturer: Nippon Electric Glass (Malaysia) SDN. BHD, average diameter: 10.5 μm, length: 3 mm
C: Irganox® 1098, manufacturer: BASF SE
D: Polyhydric alcohol: Charmor® PP100: Mixture of pentaerythritol (CAS No. 116-77-5) and different polyalcohols and esters. Manufacturer: Perstorp Charmor*DP40 2,2,2″,2”-tetrakis(hydroxymethyl)-3,3″-oxydipropan-1-ol.
Manufacturer: Perstorp
EPVOH: Ethylene polyvinyl alcohol (CAS No. 26221-27-2)
Cul/KI: Mixture of copper iodide (CAS No. 7681-65-4) and potassium iodide (CAS No.: 7681-11-0)
E: Lubricant: Calcium stearate (CAS No. 1592-23-0)
EBS: Distearylethylenediamide (CAS No. 110-30-5)
Colorant: nigrosin (CAS No. 8005-02-5, Solvent black 7)

The ingredients listed in Table 1 herebelow, with the exception of the glass fibers (separate dosing via hot feed), were premixed in a tumble mixer for 10 minutes and then extruded through a twin-screw extruder having a diameter of 25 mm and an L/D ratio of 44 at a barrel temperature of 300° C. and pelletized. To this end the natural-colored polyamide pellet material was first dried in a drying oven at 100° C. for four hours so that the moisture con-tert was below 0.1%. The obtained pellet material was injection molded on an injection molding machine at a melt temperature of 290° C. to afford standard ISO dumbbells and assessed both visually and analytically. Production of the standard ISO dumbbells having a thickness of 4 mm and a length of 150 mm was carried out via injection points arranged opposite one another at the ends of the dumbbell so that the inflowing polyamide flowed from outside into the middle of the dumbbell to form a weld seam in the middle of the shaped article. The weld seam strength was determined via a normalized breaking stress test. Mechanical properties were determined according to DIN ISO 527 or 179-2/1 eU or 179-2/1 eAf (2017 version). The amounts reported in the table are in % by weight.

Thermal aging was performed according to typical automotive standards. To this end a recirculating oven was temperature-controlled to the correct temperature. Prior to the respective steps the specimens were dried at 80° C. for 48 h at subatmospheric pressure. They were subsequently stored for the specified time in a temperature-controlled oven.

TABLE 1

| | C1 | C2 | E1 | E2 | E3 | E4 | E5 | E6 | E7 | E8 |
|---|---|---|---|---|---|---|---|---|---|---|
| Ultramid ® B27 E | 69.86 | 69.12 | 68.86 | 69.00 | 68.86 | 69.00 | 68.00 | 68.00 | 66.40 | 67.62 |
| OCV-995 | 30.00 | 30.00 | 30.00 | 30.00 | 30.00 | 30.00 | 30.00 | 30.00 | 30.00 | 30.00 |
| Charmor ® PP100 | | | 1.00 | 1.00 | | | 2.00 | | | |
| Charmor ® DP40 | | | | | 1.00 | 1.00 | | 2.00 | | |
| EPVOH | | | | | | | | | 3.00 | 1.50 |
| KI/CuI (4:1) | | 0.28 | | | | | | | | 0.28 |
| EBS | | 0.30 | | | | | | | 0.30 | 0.30 |
| Nigrosin | | 0.30 | | | | | | | 0.30 | 0.30 |
| Irganox ® 1098 | 0.14 | | 0.14 | | 0.14 | | | | | |
| Calcium stearate | 0.25 | | 0.25 | 0.25 | 0.25 | 0.25 | 0.18 | 0.18 | | |
| Breaking stress, | 98 | 98 | 98 | 98 | 98 | 97 | 97 | 96 | 94 | 98 |
| dry as molded, | | | | | | | | | | |
| [MPa] | | | | | | | | | | |
| Breaking stress, | 49 | 48 | 51 | 55 | 58 | 59 | 65 | 71 | 64 | 53 |
| after storage: | | | | | | | | | | |
| 180° C./500 h, | | | | | | | | | | |
| [MPa] | | | | | | | | | | |
| Retention [%] | 50 | 49 | 52 | 56 | 59 | 61 | 67 | 74 | 68 | 54 |
| Breaking stress, | 54 | | 64 | | 62 | | | | | |
| after storage: | | | | | | | | | | |
| 140° C./500 h, | | | | | | | | | | |
| [MPa] | | | | | | | | | | |
| Retention [%] | 55 | | 65 | | 63 | | | | | |

The dry, injection molded dumbbells (dry as molded, DAM) show only slightly different breaking elongations.

Upon thermal aging at 180′ C the effect of the polyhydric alcohol becomes clearly apparent.

The results for combinations of polyol and Irganox® 1098 of examples E1 and E3 are better than the results for the comparative example Cl. After aging at 180′ C the compositions of examples E5 and E6 show the best values for breaking stress.

1. A process for increasing the weld seam strength after thermal aging of shaped articles produced from polyamide compositions by injection molding, comprising:
admixing the polyamide composition with 0.1% to 10% by weight based on the total polyamide composition of at least one polyhydric alcohol having more than two hydroxyl groups prior to production of the shaped articles; and
injection molding the thus obtained polyamide composition to produce the shaped articles, wherein during injection molding at least two flow fronts of the molten polyamide composition collide and form at least one weld seam, wherein the polyamide composition comprises not more than 1.5% by weight of impact modifiers and the polyamide composition comprises no ethylene ionomer resins,
wherein said process employs a polyamide composition comprising
a) 30% to 99.9% by weight of at least one polyamide as component A),
b) 5% to 60% by weight of glass fibers as component B),
c) 0.01% to 2% by weight of heat stabilizers selected from the group consisting of copper compounds, secondary aromatic amines, sterically hindered phenols, phosphites, phosphonites, and mixtures thereof as component C),
d) 0.1% to 10% by weight of at least one polyhydric alcohol comprising more than two hydroxyl groups as component D),
e) 0.1% to 20% by weight of further additives as component E),
wherein the reported amounts summing to 100% by weight are based on the total composition.

2. The process according to claim 1, wherein in the polyamide composition component D) is selected from the group consisting of pentaerythritol, dipentaerythritol, tripentaerythritol, ditrimethylolpropane, D-mannitol, D-sorbitol, and xylitol or polyvinyl alcohol copolymers.

3. The process according to claim 1, wherein in the polyamide composition the polyamide A) is aliphatic and selected from the group consisting of PA 4, PA 5, PA 6, PA 7, PA 8, PA 9, PA 10, PA 11, PA 12, PA 46, PA 66, PA 69, PA 610, PA 612, PA 96, PA 99, PA 910, PA 912, and PA 1212.

4. The process according to claim 3, wherein in the polyamide composition the aliphatic polyamide A) is selected from the group consisting of PA 6, PA 66, and mixtures thereof.

5. The process according to claim 1, wherein the polyamide composition comprises an aliphatic copolyamide or terpolyamide constructed from the monomers of two or three polyamides selected from the group consisting of PA 4, PA 5, PA 6, PA 7, PA 8, PA 9, PA 10, PA 11, PA 12, PA 46, PA 66, PA 69, PA 610, PA 612, PA 96, PA 99, PA 910, PA 912, and PA 1212.

6. The process according to claim 5, wherein in the polyamide composition the aliphatic copolyamide is a PA 6/PA 66 copolymer.

7. The process according to claim 1, wherein said process employs in the polyamide composition as component A) a mixture of aliphatic polyamide A1) and aliphatic copolyamide or terpolyamide A2), wherein the weight ratio of A1) to A2) is 55:45 to 95:5.

8. The process according to claim 7, wherein the crystallization point of the mixture of the at least one polyamide and the at least one copolyamide or terpolyamide in the polyamide composition is below the crystallization points of the at least one polyamide and at least one copolyamide or terpolyamide.

9. The process according to claim 1, wherein the polyamide composition comprises 0.05% to 2% by weight of the component C).

10. The process according to claim 1, wherein in the polyamide composition component C) is selected from the group consisting of copper compounds, sterically hindered phenols, and mixtures thereof.

11. The process according to claim 1, wherein the polyamide composition comprises 10% to 60% by weight of the component B).

12. The process according to claim 1, wherein the polyhydric alcohol is not glycerol.
